(19) United States
(12) Patent Application Publication
(10) Pub. No.: US 2022/0247596 A1
(43) Pub. Date: Aug. 4, 2022

(54) SENSOR HUB, SENSOR SYSTEM, METHOD FOR TRANSMITTING SENSOR SIGNALS AND COMPUTER-READABLE STORAGE MEDIUM

(71) Applicant: STEGO-Holding GmbH, Schwäbisch Hall (DE)

(72) Inventors: Elmar MANGOLD, Zöbingen, Unterschneidheim (DE); Peter WITSCH, Schwäbisch Hall (DE); Nedzad HAMSIC, Waldenburg (DE)

(21) Appl. No.: 17/609,858

(22) PCT Filed: May 7, 2020
(86) PCT No.: PCT/EP2020/062687

§ 371 Date: Nov. 9, 2021

(30) Foreign Application Priority Data
May 10, 2019 (DE) 10 2019 112 230.9

(51) Int. Cl. H04L 12/40; G05B 19/05

(52) U.S. Cl. CPC H04L 12/40032; H04L 2012/4026; G05B 19/054; H04L 12/40013

(57) ABSTRACT

A sensor hub may be used to address complex cabling issues. Such sensor hub may include at least one sensor communication device designed to receive sensor signals from at least two sensors and/or to output signals to the at least two sensors; a computer device communicatively connected to the at least one sensor communication device and designed to generate sensor data using the sensor signals; and a transmitting device designed to transmit the sensor data to a user device via a single communications medium. The sensor data indicate addresses which are each assigned to one of the at least two sensors.

### CROSS-REFERENCE TO RELATED APPLICATIONS

This application is a Section 371 of International Application No. PCT/EP2020/062687, filed May 7, 2020, which was published in the German language on Nov. 19, 2020 under International Publication No. WO 2020/229292 A1, which claims priority under 35 U.S.C. § 119(b) to German Patent Application No. 10 2019 112 230.9, filed May 10, 2019, the disclosures of which are incorporated herein by reference.

### BACKGROUND OF THE INVENTION

The invention relates to a sensor hub, a sensor system, a method for transmitting sensor signals, and a computer-readable storage medium.

Control cabinets are often equipped with a variety of sensors to monitor the environment of sensitive and expensive equipment in the control cabinet. For example, temperature sensors or humidity sensors can be provided for monitoring. In addition, production plants are also equipped with a variety of sensors to ensure the function of the production equipment.

Sensors are usually connected via an analog or digital interface to a user module, e.g. a PLC, which regularly reads out the sensors. According to the current state of the art, digital sensors are 1-bit sensors that do not transmit measured values, but only states (e.g. on or off) in the form of bits. Analog sensors provide measured values, but no information about themselves. This means that analog sensors are not addressable and cannot be identified if several sensors transmit their data via a single connection, e.g. a bus.

This arrangement has the disadvantage that complex cabling must be laid from the control cabinet or from the production plant to the user module (higher-level control unit).

To solve these disadvantages, it is known to connect several binary sensors to the user module via a sensor hub. An IO-Link data interface, for example, can be provided between the sensor hub and the user module. In the case of an IO-Link data interface, a so-called IO-Link master which ensures communication between the sensor hub and the user module must be connected between the sensor hub and the user module. Towards the sensor hub, this is an IO-Link point-to-point connection. Towards the user module, this is usually a fieldbus connection.

With a direct connection of analog sensors to the user module, it is disadvantageous that a conversion of the analog data into user data, such as temperature, must be carried out. Furthermore, in the state of the art for binary sensors, it cannot be detected which sensor is connected to which port of a sensor hub. In the case of analog sensors, it must be specified on the user side in a register via a corresponding coding which sensor may be connected to which port, since the analog sensors themselves cannot provide any information about model and type.

It is therefore the object of the present invention to eliminate the disadvantages present in the prior art. In particular, it is an object of the invention to simplify communication with a plurality of sensors, in particular digital sensors, in particular via an IO-Link connection. Furthermore, it is in particular an object of the invention to simplify the wiring of a control cabinet.

The object may be achieved by a sensor hub, a sensor system, a method for transmitting sensor data, and/or a computer-readable storage medium as set forth in various ones of the accompanying claims.

### BRIEF SUMMARY OF THE INVENTION

The object is solved in particular by a sensor hub, comprising:
at least one sensor communication device adapted to receive sensor signals from at least two sensors;
a computer device communicatively connected to the at least one sensor communication device, which computer device is designed to generate sensor data using the sensor signals;
a transmitting device adapted to transmit the sensor data to a user device via a single communications medium,
   wherein the sensor data indicates addresses which are each assigned to one of the at least two sensors.

A core feature of the invention is that at least two sensors are addressable via a sensor hub. Thus, the sensors are also individually identifiable by a device connected to the sensor hub. This is achieved by forwarding the addresses as part of the sensor data. The cabling is simplified because the sensor data is transmitted to the user device via a single transmission medium.

For example, it may be provided that the sensors send the sensor signals to the sensor hub via an I²C bus. The computer device can be designed to convert the sensor signals into an IO-Link compatible data format and to aggregate them in this data format, wherein the only transmission medium can be formed by an IO-Link compatible transmission medium.

It is therefore made possible to code the sensors via addresses. This enables a unique identification and query of the defined sensors. A previous setting on the user side is therefore not necessary. In addition, there is the advantage that, despite the point-to-point connection between the sensor hub and the user side, it is easy to determine which sensors are connected and which sensor supplies which values when at least two sensors are connected.

It is further conceivable that the computer device may be configured to process voltage values, in particular digital voltage values which may be indicated by the sensor signals, to generate the sensor data and to determine temperature values, particle density values, humidity values, gas concentration values, vibration intensity values and/or other physical values using the sensor signals.

It is thus further possible that the desired temperature values, etc., are transmitted directly, so that a calculation of these values in a user device is not necessary.

In one embodiment, the sensor signals may indicate sensor readings.

In the context of this application, the term sensor readings may mean digitally encoded values indicated by the sensor signals. Sensor readings may indicate a series of measured values measured on a continuous scale.

Therefore, the sensor signals of different predefined sensors can be received and processed by the sensor hub.

In one embodiment, the sensor signals may indicate a temperature, a humidity, a particulate matter indication, a vibration indication, a gas indication, and/or other physical or chemical measurements.

In one embodiment, the at least one sensor communication device may be configured to be connected to at least one fieldbus system for communication with the at least two sensors.

The at least two sensors can therefore be connected to the sensor hub via a fieldbus system. For example, the known I²C bus can be used. In this case, the field bus system can be of four-wire design, for example. It is also conceivable that several sensors can be connected via a sensor communication device. In this case, a field bus system can be used which can be designed to address several participants, i.e. sensors, via a single transmission medium. Thus, a very flexible solution is provided with which different sensors can be connected to the sensor hub.

In one embodiment, the transmitting device may be configured to periodically transmit the sensor data.

In one embodiment, the sensor data within a transmission period may comprise a data packet, wherein the data packet may specify a transmission channel, a sensor status, a sensor type, and/or at least one sensor reading.

It is therefore possible to transmit data from a single sensor over the single transmission medium, wherein the data packet allows the type of sensor to be identified. Thus, a connected user device can easily determine which type of sensor provided the data.

In one embodiment, the sensor data may comprise a data packet within a transmission period, wherein the data packet indicates at least two sensor types, a sensor status, and/or at least one sensor reading for one of the at least two sensor types.

It is therefore also possible for a single data packet to have data fields for each type of sensor, so that the corresponding data is stored there. It is then not necessary for a connected user device to determine which type of sensor sent the data, since the data field used already implies this.

In one embodiment, the computer device may be configured to transmit a sensor address to a sensor using the at least one sensor communication device.

In order to determine whether a sensor is connected to a port of the sensor hub, the sensor hub may be configured to transmit a sensor address via the at least one sensor communication device.

In one embodiment, the computer device may be adapted to process a response message received from a sensor via the at least one sensor communication device in response to a/the transmitted sensor address, and to determine the type of sensor using the response message.

The sensor may therefore be configured to transmit a response message to the sensor hub in response to receiving a sensor address. For example, the sensor may be configured to transmit a response message to the sensor hub if the received address corresponds to a sensor address stored on the sensor. If the address transmitted by the sensor hub does not correspond to the sensor address stored on the sensor, the sensor may be configured to not send a response message to the sensor hub.

The sensor hub can thus determine whether, and if so, what type of sensor is connected to the sensor hub via the at least one sensor communication device by receiving or not receiving a response message. This communication may also verify the operation of the sensor. The response message can then be interpreted by the sensor hub as a life signal.

In one embodiment, the computer device may be adapted to determine that no sensor is connected to the at least one sensor communication device if no response message is received in response to a/the transmitted sensor address.

Accordingly, determining whether no sensor is connected to the at least one sensor communication device is implemented by the computer device. Thus, overall, a very efficient embodiment is disclosed for determining what type of sensor is connected to the at least one sensor communication device and whether any sensor is connected at all.

The object is also solved in particular by a sensor system comprising:
a sensor hub as described above;
at least one sensor which is designed such that it can be communicatively connected to the sensor hub, in particular is designed such that it is connected;
a user device which is designed to be communicatively connectable, in particular connected, to the sensor hub via a single communications medium.

Similar or identical advantages are obtained as have already been described in connection with the sensor hub.

In one embodiment, the at least one sensor may be a temperature sensor, a humidity sensor, a gas sensor, and/or a particle sensor, etc.

Similar or identical advantages are obtained as have already been described in connection with the sensor hub.

The object is also solved in particular by a method for transmitting sensor data, comprising the following steps:
receiving sensor signals from at least two sensors;
generating sensor data using the sensor signals, wherein the sensor data indicates addresses assigned to each of the at least two sensors;
transmitting the sensor data to a user device.

In one embodiment, the method may comprise:
transmitting a sensor address assigned to a sensor type to a first sensor of the at least two sensors;
determining that no sensor is connected to the sensor address if no response message is received in response to the transmission.

Similar or identical advantages are obtained as have already been described in connection with the sensor hub.

The object is further solved in particular by a computer-readable storage medium containing instructions for causing at least one processor to implement a method as described above when the instructions are executed by the at least one processor.

Similar or identical advantages are obtained as have already been described in connection with the sensor hub.

Further embodiments will be apparent from the subclaims.

### BRIEF DESCRIPTION OF THE DRAWINGS

The foregoing summary, as well as the following detailed description of the preferred invention, will be better understood when read in conjunction with the appended drawings:

FIG. 1 shows a schematic view of a sensor system;

FIG. 2 shows a schematic representation of a sensor hub;

FIG. 3: shows a flowchart of a method for initializing sensors connected to a sensor hub;

FIG. 4 shows an illustration of a data packet in a first exemplary embodiment;

FIG. 5 shows an illustration of a data packet in a second exemplary embodiment.

### DETAILED DESCRIPTION OF THE INVENTION

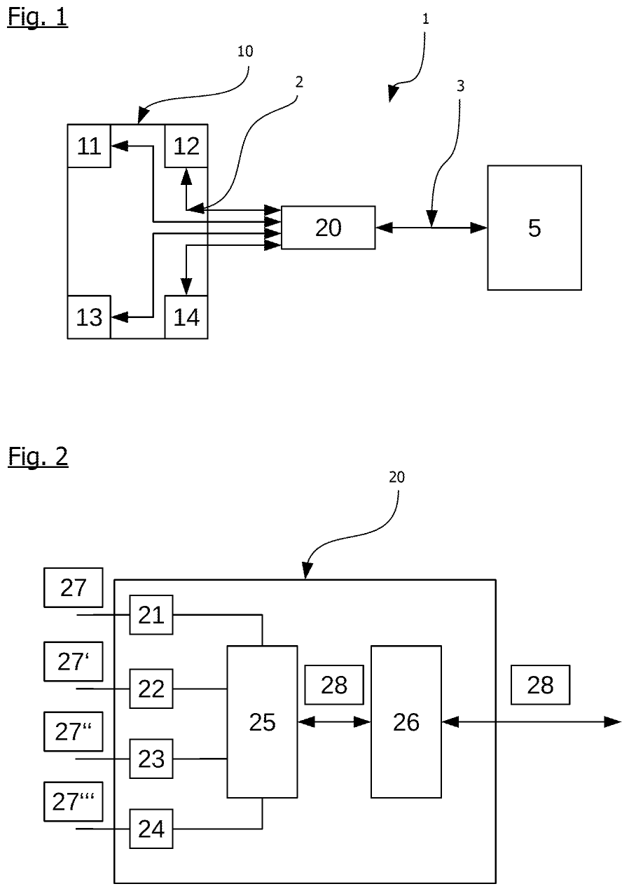

FIG. 1 shows a schematic view of a sensor system 1 comprising a production plant 10, a sensor hub 20 and a user device 5.

Four sensors 11, 12, 13, 14 are arranged in the production plant 10, i.e. a gas sensor 11, a fine dust sensor 12, a first temperature sensor 13 and a second temperature sensor 14. In addition, further components not shown are arranged in or at the production plant 10, such as a control programmable unit (PLC). Of course, in a further exemplary embodiment it is conceivable that only sensors of one type are used, for example only humidity sensors.

The sensors 11, 12, 13, 14 are each connected to the sensor hub 20 via fieldbus connections 2, for example an I²C bus connection. One way of communication, which is also used by the I²C bus, is characterized in that a four-wire connection is used, wherein one wire is used for the transmission of a clock signal and the second wire is used as a data line (¾ for the operating voltage of the sensor). Both wires are connected to a supply voltage via pull-up resistors. The fieldbus 2 is designed as a master-slave fieldbus. This means that a communication in the shown exemplary embodiment is initiated by the master. In the exemplary embodiment, the sensor hub 20 is designed as a master and the sensors 11, 12, 13, 14 are each designed as a slave.

The sensors 11, 12, 13, 14 connected via the fieldbus 2 can be addressed via addresses by the sensor hub 20. This means that the master transmits an address to the sensors 11, 12, 13, 14 via the field bus 2 and the sensor 11, 12, 13, 14 to which the address is to be assigned responds with sensor signals indicating the measured values.

The sensors 11, 12, 13, 14 are designed to transmit their measured values as sensor signals to the sensor hub 20. The sensor hub 20 is described in detail in connection with FIG. 2. The sensor hub 20 is designed to combine the received sensor signals of the sensors 11, 12, 13, 14 and to transmit them as a data packet to the connected user device 5.

A point-to-point connection is preferably used between the sensor hub 20 and the user device 5, for example an IO-Link connection 3.

A point-to-point connection is characterized in that no other devices are connected between two connected devices. Thus, with a point-to-point connection, only one other device can be connected to a port of a device.

With the invention described, it is now made possible to receive the sensor signals of a plurality of sensors 11, 12, 13, 14 via a connection on the user device 5. Furthermore, it is now possible to determine from which sensor which sensor data originates. Thus, in the exemplary embodiment of FIG. 1, it is possible to determine whether a temperature value originates from the first temperature sensor 13 or from the second temperature sensor 14. Since the position of the sensors is generally known, in the event of a rise in temperature it is also possible to determine directly where this rise in temperature occurs in the production plant 10, so that a fault can be located quickly and reliably.

FIG. 2 shows a schematic diagram of the sensor hub 20. The sensor hub 20 has four ports or terminals or connections 21, 22, 23, 24 to which the sensors 11, 12, 13, 14 are connected. Thus, in the exemplary embodiment shown, exactly one connection 21, 22, 23, 24 is provided for a sensor 11, 12, 13, 14. However, due to the fact that a field bus 2 is used for communication between the sensor hub 20 and the sensors 11, 12, 13, 14, it is also conceivable that more than one identical or different sensor 11, 12, 13, 14 is connected via a connection or port 21, 22, 23, 24.

In the context of this application, the connections 21, 22, 23, 24 are also referred to as sensor communication devices.

The sensors 11, 12, 13, 14 transmit respective sensor signals 27, 27′, 27″, 27′″ to the computer device 25 via the connections 21, 22, 23, 24. The computer device 25 is configured to receive and process the sensor signals 27, 27′, 27″, 27′″. For example, the computer device 25 is adapted to calculate a temperature from voltage values 27 transmitted by a temperature sensor 13. In this respect, the computer device 25 may be appropriately preconfigured so that it is possible to assign a corresponding temperature to a digital data packet.

However, it is also conceivable that the computer device 25 performs more advanced calculations, such as determining an average value over a certain time interval, for example 24 hours.

Finally, in some exemplary embodiments, the computer device is adapted to form a virtual sensor. This means that the computer device 25 is adapted to process the values from at least one sensor 11, 12, 13, 14 and to transmit them as sensor data to the user device 5. For example, it is possible to create a virtual sensor which always indicates the temperature average of the last 24 hours.

The computer device 25 may further comprise a memory device in which, for example, the sensor data is temporarily stored. The addresses of the sensors 11, 12, 13, 14 may also be stored there.

The processed sensor signals 27, 27′, 27″, 27′″ are additionally aggregated by the computer device 5 as sensor data 28. This means that the sensor signals 27, 27′, 27″, 27′″ can be transmitted further together. For this purpose, the sensor data 28 are sent to a transceiver 26 which transmits the sensor data 28 to the user device 5.

The transceiver 26 may also be referred to as the transmitting device.

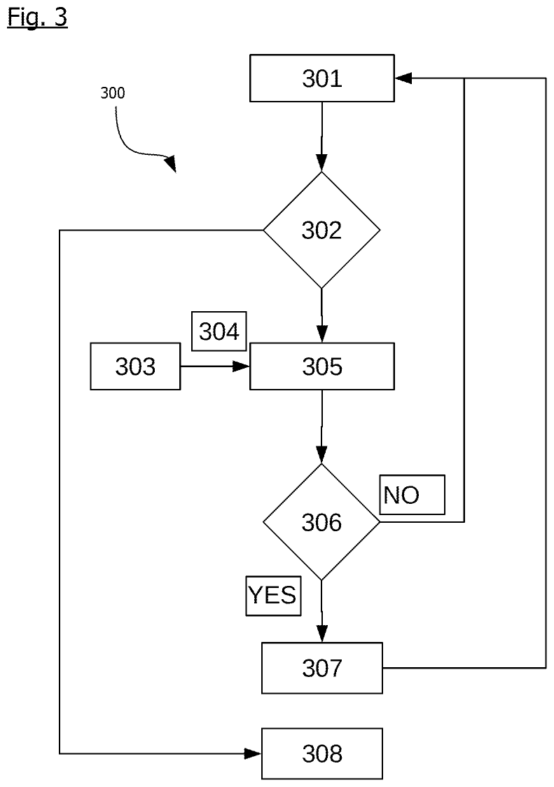

FIG. 3 is a flowchart illustrating an initialization procedure 300 for sensors 11, 12, 13, 14.

In the initialization step 301, the sensor hub 20 is switched on and thus supplied with power. Furthermore, it is checked whether all sensors 11, 12, 13, 14 known to the sensor hub 20 have already been initialized. For this purpose, the sensor hub 20 has a memory device in which a plurality of sensor addresses are stored. Each address is assigned a sensor type and an indication as to whether the associated sensor 11, 12, 13, 14 is already initialized.

In the test step 302, the computer device 25 of the sensor hub 20 checks whether at least one address has not yet been initialized. If this is the case, the method continues with the transmission step 305. If all sensors 11, 12, 13, 14 have already been initialized, the method ends with the end step 308.

In the transmission step 305, a sensor address 304 which is not yet initialized is read out from the memory device 303. The address 304 is transmitted in the transmission step 305 via a sensor communication device 21, 22, 23, 24.

If a response to the transmitted address 304 is received in the receiving step 306, an assignment from the address 304 to the sensor communication device 21, 22, 23, 24 used is stored in the storing step 307. Thus, from this point on, it is known which sensor 11, 12, 13, 14 can be reached via which sensor communication device 21, 22, 23, 24.

If no response is received to the sending of address 304 at step 306, the method proceeds to step 301.

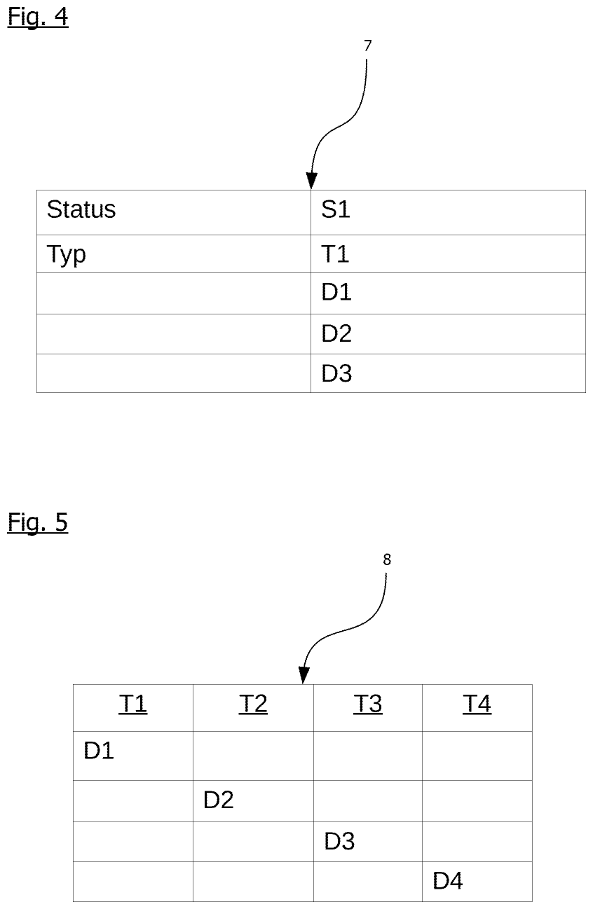

FIGS. 4 and 5 illustrate two possible data formats of how the sensor data 7, 8 can be transmitted from the sensor hub 20 to the user device 5.

FIG. 4 shows an exemplary embodiment in which the sensor data 7 for a channel, i.e. for a sensor communication device or a connection 21, 22, 23, 24, indicates a status S1, a sensor type T1 and user data D1-D4. The status S1 indicates which data is transmitted as user data D1-D4. For example, the status S1 may indicate that temperature data is encoded as user data D1-D4. The sensor type D1 indicates what kind of sensor it is, e.g. a temperature sensor or a humidity sensor.

The sensor data 7 may also include the data for all channels, i.e. sensor communication devices or connections 21, 22, 23, 24. Thus, with reference to FIG. 1, the sensor data 7 comprises the data of FIG. 4 four times, wherein each channel indicates the data for a sensor 11, 12, 13, 14.

The described exemplary embodiment has the advantage that little process data must be transmitted, since the data necessary for a sensor can always be precisely transmitted in a compact manner at all times. A disadvantage is that the status S1 must be evaluated in order to determine what data is being transmitted.

This disadvantage is addressed by the exemplary embodiment of FIG. 5. FIG. 5 shows exemplary sensor data 8 comprising, for each channel, fields for all possible sensors 11, 12, 13, 14. This means that for a first channel data fields for all possible sensor types T1-T4 are provided. Thus, FIG. 5 shows data fields for sensor types T1, T2, T3 or T4. In the exemplary embodiment shown, each sensor type T1-T4 is assigned exactly one data field for user data D1-D4.

The definition of the sensor types T1-T4 in the sensor data 8 is thereby fixed, so that it can be recognized from the use of the data fields D1-D4 which type of data is involved. For example, if T1 is specified as a temperature sensor, it can be recognized from the use of the data field D1 with a value that the data in the data field D1 is temperature data of a connected temperature sensor 13. Thus, no status needs to be read out and interpreted.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SIGNS

1 Sensor system
2 Fieldbus connection
3 IO-Link cable
5 User device
10 Production plant
11 Gas sensor
12 Fine dust sensor
13 First temperature sensor
14 Second temperature sensor
20 Sensor hub
21, 22, 23, 24 Port/terminal
25 Microcontroller
26 Transceiver
7, 8 27, 27′, 27″, 27′″ Sensor signals
28 Sensor data
300 Initialization procedure
301 Initialization step
302 Test step
303 Storage device
304 Address
305 Transmission step
306 Receive step
307 Storage step
308 End step
S1 Status
T1-T4 Sensor type
D1-D4 Datum

1. A sensor hub, comprising:
at least one sensor communication device adapted to receive sensor signals from at least two sensors;
a computer device which is communicatively connected to the at least one sensor communication device, and which is designed to generate sensor data using the sensor signals;
a transmitting device adapted to transmit the sensor data to a user device via a single communications medium,
wherein
the sensor data indicate addresses which are each assigned to one of the at least two sensors.

2. The sensor hub according to claim 1,
wherein
the sensor signals indicate sensor readings.

3. The sensor hub according to claim 1, wherein
the sensor signals indicate a temperature, a humidity, a fine dust indication, a vibration indication, a gas indication and/or further physical or chemical measurands.

4. The sensor hub according to claim 1, wherein
the at least one sensor communication device is designed to be connected to at least one fieldbus system for communication with the at least two sensors.

5. The sensor hub according to claim 1, wherein
the transmitting device is designed to transmit the sensor data periodically.

6. The sensor hub according to claim 5,
wherein
the sensor data within a transmission period comprise a data packet, wherein the data packet indicates a transmission channel, a sensor status, a sensor type and/or at least one sensor reading.

7. The sensor hub according to claim 5,
wherein
the sensor data within a transmission period comprises a data packet, wherein the data packet indicates at least two sensor types, a sensor status, and/or at least one sensor reading for one of the at least two sensor types.

8. The sensor hub according to claim 1, wherein
the computer device is adapted to transmit a sensor address to a sensor using the at least one sensor communication device.

9. The sensor hub according to claim 8,
wherein
the computer device is adapted to process a response message from a sensor received via the at least one sensor communication device response to a/the transmitted sensor address and to determine the type of the sensor using the response message.

10. The sensor hub according to claim 8,
wherein
the computer device is adapted to determine that no sensor is connected to the at least one sensor communication device when no response message is received in response to a/the transmitted sensor address.

11. A sensor system, comprising:
the sensor hub according to claim 1;
at least one sensor which is designed to be communicatively connectable to the sensor hub; and
a user device which is designed to be communicatively connected to the sensor hub via the single communications medium.

12. The sensor system according to claim 11,
wherein
the at least one sensor is designed as a temperature sensor, a humidity sensor, a gas sensor and/or as a particle sensor.

13. A method for transmitting sensor data, comprising the steps of:
receiving sensor signals from at least two sensors;
generating sensor data using the sensor signals, wherein the sensor data indicates addresses each assigned to one of the at least two sensors; and
transmitting the sensor data to a user device.

14. The method according to claim 13,
further comprising:
transmitting a sensor address assigned to a sensor type to a first sensor of the at least two sensors;
receiving a response message from the first sensor; and
assigning the sensor address to the first sensor.

15. The method according to claim 13, further comprising:
transmitting a sensor address assigned to a sensor type to a first sensor of the at least two sensors; and
determining that no sensor is connected to the sensor address when no response message is received in response to the transmission.

16. A computer-readable storage medium containing instructions that cause at least one processor to implement the method according to claim 13, when the instructions are executed by the at least one processor.
